(19) United States
(12) Patent Application Publication
(10) Pub. No.: US 2013/0030863 A1
(43) Pub. Date: Jan. 31, 2013

(54) TREND-BASED TARGET SETTING FOR PROCESS CONTROL

(71) Applicants: Aaron D. Civil, Rochester, MN (US); Jeffrey G. Komatsu, Kasson, MN (US); John M. Wargo, Poughkeepsie, NY (US); Emmanuel Yashchin, Yorktown Heights, NY (US); Paul A. Zulpa, Woodbury, CT (US)

(72) Inventors: Aaron D. Civil, Rochester, MN (US); Jeffrey G. Komatsu, Kasson, MN (US); John M. Wargo, Poughkeepsie, NY (US); Emmanuel Yashchin, Yorktown Heights, NY (US); Paul A. Zulpa, Woodbury, CT (US)

(73) Assignee: INTERNATIONAL BUSINESS MACHINES CORPORATION, Armonk, NY (US)

(21) Appl. No.: 13/409,920

(22) Filed: Mar. 1, 2012

Related U.S. Application Data
(63) Continuation of application No. 13/194,910, filed on Jul. 30, 2011.

(51) Int. Cl. G06Q 30/02

(52) U.S. Cl. 705/7.29

(57) ABSTRACT

Determining a suitable target for an entity (such as a product) in a process control environment, based on observed process control data. A preferred embodiment organizes data in a hierarchical structure designed for automating the target-setting process; derives target “yardsticks” for various components based on this data structure; employs techniques to estimate proportions using sample-size-based trimming in conjunction with bias-correction techniques (where appropriate); and derives targets based on combining yardsticks and confidence regions for parameters that characterize component quality

### BACKGROUND

The present invention relates to computing systems, and deals more particularly with computing targets for use in process control, based on trends in observed process control data.

Modern businesses rely heavily on use of analytics, measures, and key process indicators for process control. Many times, however, the analytics and measures used for evaluating trends employ arbitrary or subjective targets. For example, process control targets are sometimes based solely on an organizational requirement for continuous improvement, with little or no regard for factors such as natural volatility, recent and/or future investment in new products, and process capability.

### BRIEF SUMMARY

The present invention is directed to trend-based target setting. In one aspect, this comprises: selecting a particular entity from among a plurality of entities; obtaining historical process control data for a group of related entities, the group comprising the selected entity and at least one additional one of the plurality of entities; determining, from the obtained historical process control data, an observed number of non-conforming instances of each of the entities in the group and a total number of instances of each of the entities; computing a rate of non-conformance, for each of the entities in the group, from the determined number of non-conforming instances and the determined total number of instances; computing a representative rate of non-conformance for the group, using the computed rate of non-conformance for each of the entities in the group; and setting, as a process control target for the selected entity, an expected rate of non-conformance derived from the rate of non-conformance computed for each of the entities in the group and the computed representative rate of non-conformance for the group.

Embodiments of these and other aspects of the present invention may be provided as methods, systems, and/or computer program products. It should be noted that the foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined by the appended claims, will become apparent in the non-limiting detailed description set forth below.

### BRIEF DESCRIPTION OF THE SEVERAL VIEWS OF THE DRAWINGS

The present invention will be described with reference to the following drawings, in which like reference numbers denote the same element throughout.

FIGS. 1-2 (where FIG. 2 comprises FIGS. 2A-2B) provide flowcharts depicting logic which may be used when implementing an embodiment of the present invention;

FIGS. 3A-3C provide charts that illustrate confidence intervals and confidence bounds;

FIG. 4 provides a set of equations that may be used in an embodiment of the present invention as it evaluates trends in observed process control data and sets a target for a product in view of the trends;

FIG. 5 provides a graph that uses sample data to illustrate some of the computations performed when determining a target for a product;

FIG. 6 provides a chart of sample data values that are used to illustrate some of the computations performed when determining a product's target;

FIG. 7 provides a flowchart depicting logic which may be used when implementing a multi-level weighting algorithm;

FIG. 8 depicts a data processing system suitable for storing and/or executing program code.

### DETAILED DESCRIPTION

Traditional process control strategies are often based on arbitrary or subjective targets, as noted earlier. Particular business goals or management-directed initiatives may be used as targets, for example, such as “achieve zero defects” or setting a year-to-year continuous improvement requirement. Establishing targets may be a best-effort manual process when using conventional techniques, and organizational targets may be selected somewhat arbitrarily for a baseline, with little thought or analysis as to whether a particular target is valid or suitable for the environment. When targets are over-aggressive or under-aggressive, a business encourages undesirable behavior. A goal of zero defects may be unreasonable and unattainable in some environments, for example, and may result in too narrow focus on specific and obvious deficiencies in process quality that preclude or delay awareness of other salient quality issues. Furthermore, insistence on such goal may lead to employee frustration and resulting carelessness. In today's high-velocity, highly-competitive business environment, targets should be selected to reinforce only desirable behavior.

The present invention is directed to trend-based target setting and may be used in a process control environment to derive practical, objective targets which are determined to be suitable for the environment, based on observed process control data. As will be more fully described hereinafter, a preferred embodiment of the present invention comprises organizing data in a hierarchical structure designed for automating the target-setting process; deriving target “yardsticks” for various components based on this data structure; employing techniques to estimate proportions using sample-size-based trimming in conjunction with bias-correction techniques (where appropriate); and deriving targets based on combining yardsticks and confidence regions for parameters that characterize component quality.

A particular process may involve a large number of elements that need to be measured, and an equally large number of targets may be needed as well. The term “product” is used hereinafter to refer to a component or entity in a process, although this is by way of illustration but not of limitation, as targets may be set for entities other than products without deviating from the scope of the present invention. An embodiment of the present invention iteratively evaluates observed process control data to set revised targets, for example at periodic intervals. If this evaluation indicates that a revised target is not suitable, the target is automatically adjusted (i.e., revised) and the resulting value is set as the revised target. Suitable targets are therefore used in an ongoing manner. Accordingly, when using an embodiment of the present invention, the feasibility of achieving performance objectives may be significantly improved, and confidence in results of automated trend analysis may increase.

When a product is new, there is typically no product-specific data available pertaining to how that product performs in a particular process environment. Traditional process control techniques may therefore set targets for new products using a best-guess approach. An embodiment of the present invention, by contrast, uses previously-observed data from similar products (also referred to herein as “related products”) to establish a baseline target for a new product. A product hierarchy is used in a preferred embodiment, whereby a particular product is classified as part of a group, and observed data for other group members is used to set a baseline target for the product. In one approach, the products are individual parts, the hierarchy corresponds to commodities which are each composed of one or more parts, and the parts that form a particular commodity are the members of a corresponding group. A multi-level hierarchy may be used. For example, commodities which are comprised of parts may, in turn, be group members for an assembly or other higher-level entity.

When a product is newly introduced, it will typically have a relatively low sample size—that is, process control data for a relatively low number of instances of the product may be observed in the process. According to an embodiment of the present invention, this will cause the product's target to be more heavily influenced by the average values of its group (as will be shown in the equations discussed below). As a product matures, the product will typically accumulate more observed process control data, and this product-specific data will cause the product's target to be increasingly influenced by its own history.

For ease of reference, the products which are members of a group are also referred to herein as “related products”. For example, parts of a group which together form a commodity are considered to be related products. While the part/commodity relationship is used herein when discussing embodiments of the present invention, this is by way of illustration and not of limitation, and the members of a particular group may be related in other ways without deviating from the scope of the present invention. For example, group members might be selected based on anticipated or observed similarities in process control data for the respective products.

Use of observed process control data for related products, as disclosed herein, enables the target for a particular product to be based on a broad sampling of data. In addition to using the related product data to set a baseline target for a new product, as discussed above, an embodiment of the present invention also considers the related product data when subsequently setting a revised target for the product (in addition to considering previously-observed data from the same product). The observed data from the group members therefore impacts targets beyond the initial (i.e., baseline) target. In particular, an embodiment uses observed data for all group members when determining whether a product's target is too strict or too lenient, and also when evaluating suitability of a target. Optionally, observed data for a next-higher level in the hierarchy may also be used in these computations.

The term “non-conformance” is used herein to refer to instances of a product that fail to conform to the process control target for the product. Non-conformance is measured in terms of number of occurrences, and also in terms of the rate of non-conformance (which is also sometimes referred to as the product's “fallout rate”). The rate of non-conformance, or non-conformance rate, is computed by dividing the number of non-conforming instances of a product by the total number of observed instances of that product. This non-conformance rate is also referred to herein as “NCR”. For example, a process control target might be set (as an illustrative example) to have no more than 3 defective widgets in every 1,000 widgets that are manufactured. In this example, the target NCR is therefore 0.3 percent or 0.003.

While discussions herein refer primarily to establishing and evaluating targets for products, an embodiment of the present invention may also or alternatively be used to establish and evaluate targets for entities at higher levels in a hierarchy, such as commodity-level targets and assembly-level targets. Accordingly, references herein to targets for products is by way of illustration but not of limitation.

As a revised target is computed for a product and is examined in view of observed instances of non-conformance for the product and its related products, an automated determination is made as to whether that target is suitable for the product. In an embodiment of the present invention, suitability is evaluated by comparing a product's revised target against observed process control data for the group (as discussed in further detail below), in view of confidence bounds that provide a level of tolerance for the suitability of the revised target. When the suitability evaluation determines that the product will likely out-perform the revised target by more than a threshold amount (e.g., the revised target is outside the lower confidence bound for the product), this indicates that the revised target is too lenient, and an embodiment of the present invention therefore automatically establishes a stricter target. On the other hand, when the suitability evaluation determines that the product will likely under-perform the revised target by more than a threshold amount, this indicates that the revised target is too strict, and an embodiment of the present invention therefore automatically establishes a more lenient target.

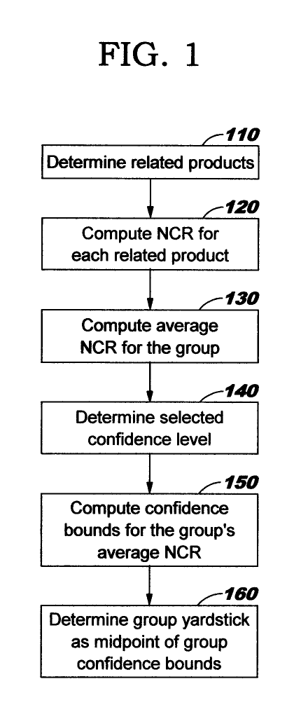

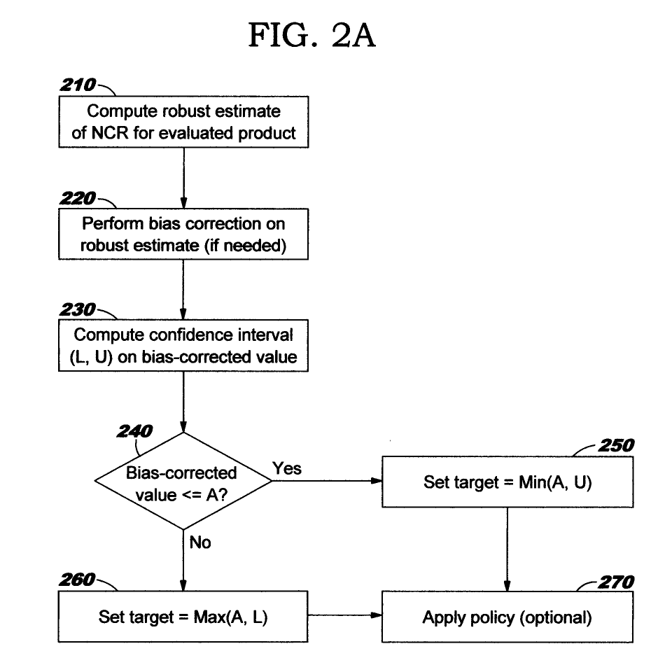

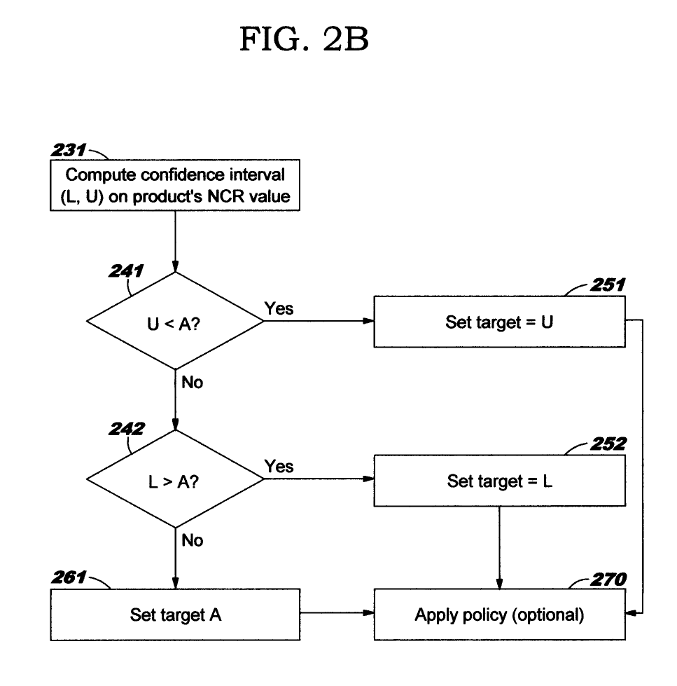

Further details will now be provided with reference to the illustrations in the figures. FIGS. 1-2 provide flowcharts depicting logic which may be used when implementing an embodiment of the present invention. Note that the disclosed approach is adapted for setting an initial target for a new product, and also for setting an adjusted target for an existing product, and both scenarios may therefore be considered as setting a target for a product. The discussion that follows describes a single iteration of setting a target for a single product, where this technique may be applied iteratively—for example, at configured intervals and/or in response to predetermined events—to evaluate ongoing process control conditions and to set product-specific targets accordingly.

The processing for determining a product's process control target begins by determining several values for the group as a whole, and this processing is depicted in FIG. 1. Accordingly, Block 110 of FIG. 1 begins by determining the related products that will be used—that is, all products in the group of which the evaluated product is a member. (The term “evaluated product” is used in this discussion to refer to the product for which the target is being analyzed, whereas the terms “related products” and “products in the group” refer to both the product for which the target is being analyzed and also the other members of the group.) In one approach, this may be done by consulting a data structure in which an identifier of the evaluated product is used as a key to retrieve identifiers of the related products.

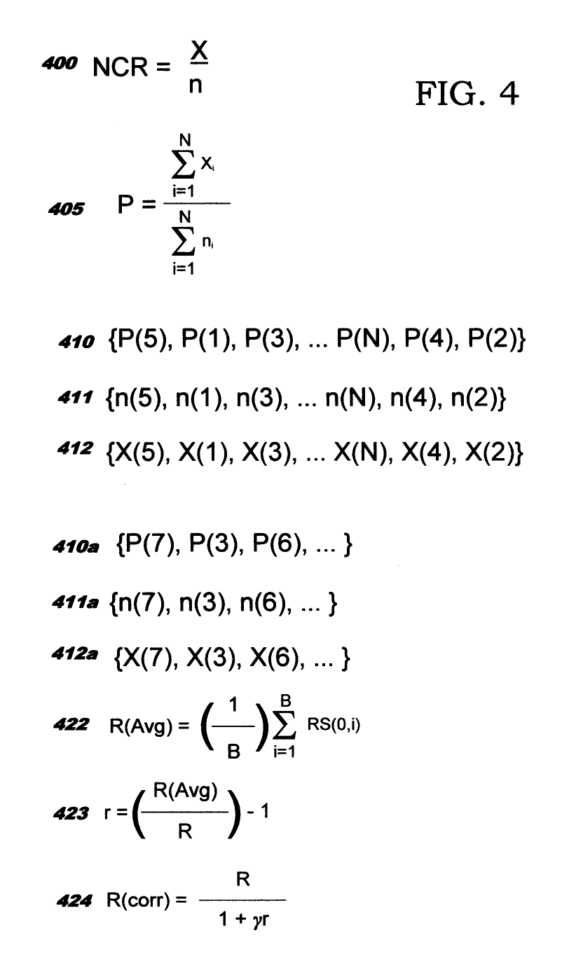

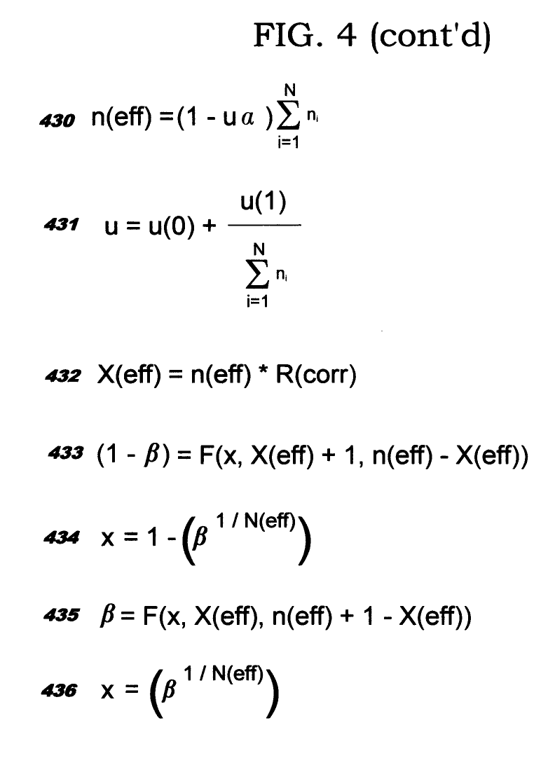

Block 120 the computes the NCR for each of the related products. This is done, according to an embodiment of the present invention, by determining the number of items tested (also referred to as the sample size) for each of the related products which were identified at Block 110 and the observed number of non-conforming items for each related product in the group. A product that is performing outside its previously-established upper or lower confidence bounds is referred to herein as a “non-conforming item”, or “NCI”. The product-specific sample size is referred to herein as “n”, and the observed number of NCIs for a particular product is referred to herein as “X”. Accordingly, the computation at Block 120 may be represented as shown at equation 400 of FIG. 4.

Suppose, as a simple example, that the product of interest is a member of group containing 4 related products, and that a single sample is available for each of these products. Further suppose that the 4 samples represent testing of 1000, 10000, 1000, and 10000 items and that the number of NCIs in the respective samples is 1, 20, 5, and 40. Accordingly, the product-specific NCR values computed at Block 120 are 0.001, 0.002, 0.005, and 0.004, respectively.

Block 130 then computes an average NCR over the NCR values of the products in the group. In the simple example presented above, this computation is (0.001+0.002+0.005+0.004)/4=0.003. That is, the average rate of non-conformance over all of the products in the group is 0.3 percent in this example. Note that this group average is computed as a straight average, without weighting in view of sample size, according to a preferred embodiment. In this manner, a group member that has a long history and/or a relatively large sample size is prevented from dominating the group-specific calculations. In an alternative approach, however, product-specific NCRs may be weighted somewhat higher for group members with higher sample sizes, without deviating from the scope of the present invention (although it is preferred that this weighting is not directly proportional to the sample size to avoid skewing the group-specific calculations).

In an alternative approach, the product-specific NCRs computed at Block 120 may be trimmed prior to averaging them at Block 130, without deviating from the scope of the present invention. Refer to the discussion of trimming that is presented below with reference to the processing of Block 210 for a description of how a product's process control data may be trimmed to remove outliers, thereby resulting in a more robust NCR for the product.

Block 140 determines a selected confidence level, referred to herein as β (i.e., Beta), which is used to establish a confidence interval. The confidence level may be obtained by retrieving a predetermined number from a repository, such as a configuration file, or in another manner—including by prompting a user, or by hard-coding a fixed value into the embodiment. By way of illustration only, discussions herein use a confidence level of β=0.1. This value of β establishes a 90 percent confidence interval (i.e., 1−(β=0.9).

Block 150 uses the selected confidence interval from Block 140 to compute confidence bounds for the group's average NCR, based on the summation of the sample sizes for each of the products in the group. Techniques for computing confidence bounds are known, and one of ordinary skill in the art readily understands how to compute confidence bounds from the available data.

Referring again to the example, suppose (for ease of illustration) that the total sample size over all 4 products is 10,000, instead of 22,000 as indicated earlier. Given a 90 percent confidence interval and the total sample size of 10,000, then the bounds of a 2-sided 90 percent confidence interval are (0.00216, 0.00407). The bounds of this interval are therefore 0.00216 as the lower bound, and 0.00407 as the upper bound. In other words, there is a 90 percent confidence that the non-conformance rate for this sample size of 10,000 will be between 0.216 percent and 0.407 percent.

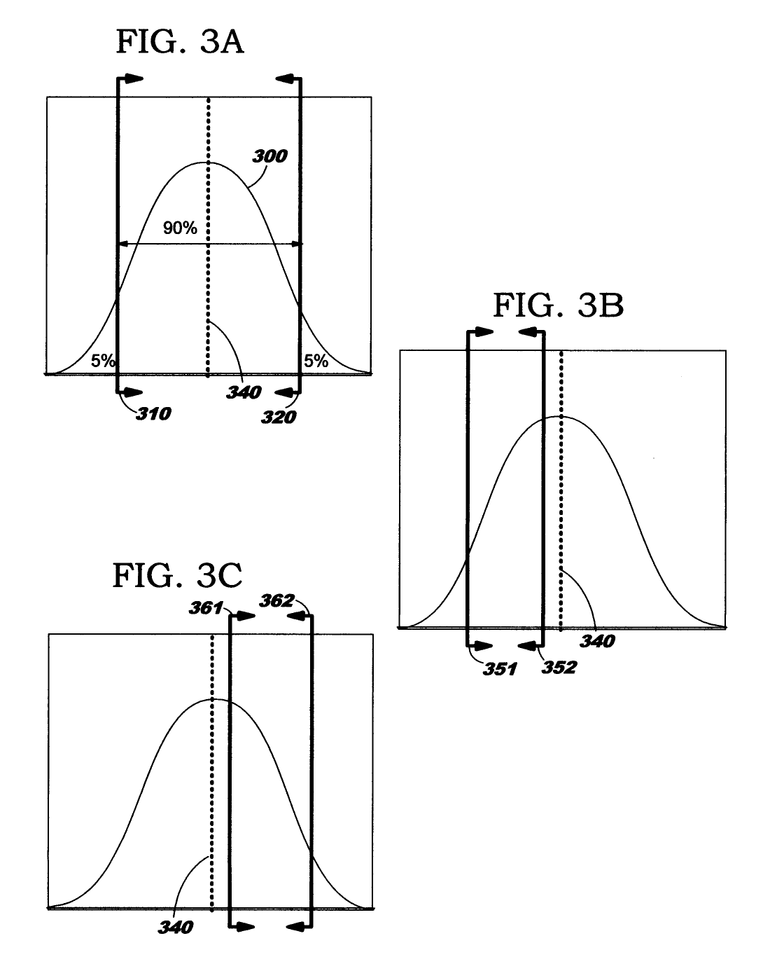

FIG. 3A provides a chart that illustrates the concept of a 2-sided 90 percent confidence interval with reference to a graph 300. As shown therein, the area of the graph within brackets 310, 320 represents the 90 percent confidence interval. (Note that the shape of graph 300 is provided only for illustrative purposes, and is not intended to represent data used by an embodiment of the present invention.)

Now that the bounds (L, U) of the confidence interval for the group's average NCR have been computed, Block 160 determines a midpoint between those bounds. This value is also referred to equivalently herein as “A” and the group “yardstick”. In the above example where the confidence interval is (0.00216, 0.00407), the midpoint is (0.00216+0.00407)/2=0.0031. Note that this midpoint value is slightly higher than the group average NCR computed at Block 130, which is 0.003 in the example. This is because the confidence bounds are not precisely symmetric. However, given a non-trivial sample size, this simple computation of a group yardstick is deemed to be sufficient. A representative group yardstick is shown at 340 in FIG. 3A for the confidence interval 310, 320.

In one alternative approach, the yardstick may be computed as a weighted average of confidence bounds, rather than as a simple average. A choice of whether to use a weighted or simple average may be made according to the preference of a process control professional. Other techniques for computing a yardstick as a representative value for the NCR of a group may be used without deviating from the scope of the present invention. For example, prior knowledge about where the yardstick should be may be taken into account, where this prior knowledge might be based (for example) on behavior of similar products, for programmatically manipulating the location of the yardstick. This could be achieved, for example, using Bayesian techniques. An advantage of using confidence bounds, however, is that it leads to a yardstick even when no failures are observed and the user chooses not to employ any prior information about where the yardstick should be located.

Note that by first computing product-specific estimates in Block 120 and then averaging those values in Block 130, without weighting by product-specific sample size, products with a long-running history are prevented from dominating the value of the group yardstick. Alternative techniques for computing the group yardstick may be used without deviating from the scope of the present invention, however.

When the evaluated product is new, it has no observed process control data for inclusion in the processing of FIG. 1; observed data from other products in the group is therefore used to establish an initial target for the new product, using the disclosed techniques. In subsequent iterations, observed data for the evaluated product will be available and are included in the computations.

Following completion of the processing in FIG. 1, the group yardstick and average NCR over the group have been computed from observed process control data, and this information can therefore be used when determining an estimate of how the evaluated product “should” behave in the future. The processing for determining a product's process control target therefore continues, and this processing is illustrated in FIG. 2, which comprises FIG. 2A (illustrating a first approach) and FIG. 2B (illustrating a second approach). Note that the processing of each block of FIG. 2 will first be described at a high level, and a more detailed discussion of individual blocks will then be presented with reference to particular mathematical computations that may be used to carry out the function of that block.

Block 210 computes a “robust” estimate of the NCR for the evaluated product. This robust estimate is referred to herein as “R”. A simple example of computing average NCR for a group was discussed above, referring to a group containing 4 products and data from a single sample (i.e., from a single time interval) for each product. However, data from a single sample may be unreliable in some scenarios. Observed process control data may also contain samples where the observed data has extremely high and/or extremely low counts of NCI, and these extreme values may lead to estimates that are not suitable for target-setting. An embodiment of the present invention is therefore adapted for computing a robust estimate of NCR for the evaluated product that avoids these issues. One approach for computing a robust estimate of NCR is discussed in detail below, following the discussion of Block 270.

A bias correction process may be performed on the robust estimate R, if needed, as shown at Block 220. In one embodiment, the bias correction is performed when the estimated bias in R is significantly different from zero. This bias-corrected estimate is referred to herein as “R(corr)”. In an embodiment of the present invention, the bias correction process comprises using replicated sequences of periodic robust NCR values (that is, robust NCR values corresponding to intervals, such as weeks, for which samples are taken) for the evaluated product, deriving a value that is then corrected for bias. One approach for performing this bias correction is discussed in detail below, following the discussion of Block 270. (Note that if the robust estimate of NCR is not significantly different from zero, then the bias correction processing is preferably omitted.)

At this point in the processing of FIG. 2A, a bias-corrected estimate of the evaluated product's non-conformance rate has been computed, and is a candidate value for the evaluated product's new target. However, an embodiment of the present invention is adapted to verify whether this target is considered to be suitable for the evaluated product, in view of the observed process control data, and set a different target if necessary for providing a suitable target.

An embodiment of the present invention uses upper and lower confidence bounds (U, L) as a guideline for setting the target, thereby providing limits on how different the new target can be from the target that is currently in use for the product. Accordingly, Block 230 computes a confidence interval (L, U) for the bias-corrected robust estimate created at Block 220 (or for the robust estimate created at Block 210, as appropriate). One approach for computing this confidence interval is discussed in detail below, following the discussion of Block 270. (Note that the confidence interval computed at Block 230 is for a particular product, whereas the confidence interval that was computed at Block 150 is for a group of products.)

Block 240 tests whether the bias-corrected robust estimate is less than or equal to the value of the group yardstick “A” (which was computed at Block 160 of FIG. 1 to represent the midpoint of the 2-sided confidence interval for the group's average NCR). With reference to the graph 300 of FIG. 3A, this test at Block 240 comprises testing whether the evaluated product's bias-corrected robust estimate falls in the left-hand side of graph 300 (including the midpoint A at 340). When the test in Block 240 has a positive result, this indicates that the non-conformance rate for the evaluated product is expected to be less than, or equal to, the average non-conformance rate for the group as a whole. Accordingly, control reaches Block 250, which sets the evaluated product's target to the lower of (i) the group yardstick, A, and (ii) the upper bound, U, of the confidence interval computed at Block 230 for the evaluated product.

For example, suppose that the confidence bounds for the evaluated product are as shown at 351, 352 in FIG. 3B, where the confidence interval (L, U) for the evaluated product lies entirely below the group yardstick 340. This indicates that the product is expected to perform better (i.e., to have a lower rate of non-conformance), on average, than the group, as noted above. Accordingly, an embodiment of the present invention sets the target for the evaluated product to the product's upper bound 352, which effectively “rewards” the product for its good performance by giving it a more lenient target while still keeping the target consistent with the product's capability. Therefore, the target is considered to be realistically achievable.

Following the processing of Block 250, control then transfers to Block 270, which is discussed below.

When the test at Block 240 has a negative result, this indicates that the non-conformance rate for the evaluated product is expected to be greater than the average non-conformance rate for the group as a whole (i.e., greater than the group yardstick). Accordingly, control reaches Block 260, which sets the evaluated product's target to the higher of (i) the group yardstick, A, and (ii) the lower bound, L, of the confidence interval computed at Block 230 for the evaluated product.

For example, suppose that the confidence bounds for the evaluated product are as shown at 361, 362 in FIG. 3C, where the confidence interval for the evaluated product lies entirely above the group yardstick 340. This indicates that the product is expected to perform worse (i.e., to have a higher rate of non-conformance), on average, than the group, as noted above. Accordingly, an embodiment of the present invention sets the target for the evaluated product to the product's lower bound 361, which effectively “punishes” the product for its poor performance by giving it a more aggressive target while still keeping the target consistent with the product's capability.

Note that when the evaluated product's confidence interval (L, U) contains the group yardstick A, the processing at Block 250 results in setting the evaluated product's target to the group yardstick. This may be done because the evaluated product is deemed to be too “noisy”. Alternatively, when the group yardstick does not fall within the evaluated product's confidence interval (L, U), then the processing of Blocks 250 and 260 results in setting the evaluated product's target to the bound U or L that is closer to the group yardstick.

Following the processing of Block 260), control transfers to Block 270.

Referring now to FIG. 2B, an alternative approach to the computations in Blocks 210-260 of FIG. 2A will now be discussed before returning to the discussion of Block 270. It is noted that in general, confidence bounds for a product's non-conformance rate may be obtained without first obtaining an estimate (whether bias-corrected or otherwise). Accordingly, the approach shown in FIG. 2B is based on the product's NCR value rather than a bias-corrected estimate thereof. Block 231 therefore computes a confidence interval (L, U) for the product's NCR value (which was previously determined at Block 120 of FIG. 1).

Block 241 tests whether the product's upper confidence bound, U, is less than the group yardstick, A. If so, then Block 251 sets the product's target to the product's upper confidence bound. (This is the scenario illustrated by the example in FIG. 3B, and the target is set to upper bound 352 in this scenario.) When the test in Block 241 has a negative result, Block 242 tests whether the product's lower confidence bound, L, is greater than the group yardstick. If so, then Block 252 sets the product's target to the product's lower confidence bound. (This is the scenario illustrated by the example in FIG. 3C, and the target is set to lower bound 361 in this scenario.) If neither of the tests in Blocks 241 and 242 has a positive result, then Block 261 sets the product's target to the value of the group yardstick. (This is the scenario illustrated by the example in FIG. 3A, and the target is set to yardstick 340 in this scenario.)

Returning now to the discussion of FIG. 2A, Block 270 represents optional post-processing that may be performed to selectively adjust the revised target in view of one or more policies (and this optional post-processing is also shown in FIG. 2B). Use of policy allows organizational goals and requirements to be factored into the target-setting process as a refinement of the target. Policies may include, by way of illustration only, policy that allows for adjusting a product's target based on the product age; policy that adjusts the target for a particular product based on product-specific guidelines; policy that adjusts a product's target in view of a threshold non-conformance rate; and policy to adjust or constrain the target for products having a low sample size. Policy may be used for other reasons as well, according to the needs of a particular environment, for controlling whether a target is accepted as generated or is to be modified. For example, it might be desirable to limit the frequency of change to a target so as to avoid confusing users who are interacting with the process control system. Accordingly, the examples provided herein are merely illustrative. Several example policies will now be discussed.

In a general sense, it is observed that the life cycle stage of a particular product often influences a process involving that target (where a “life cycle” is the period of time from initial development of a product to the end of the product's life or use). For example, when a product is newly introduced into a process, a relatively high non-conformance rate may occur for the product, and this is generally considered to be normal, expected behavior. Certain products also experience increasing rates of non-conformance as they near the end of their life cycle. A policy directed to a new, or relatively new, product may therefore allow the product's target to vary from the confidence interval by a higher degree than a more stable product. A policy directed to a product reaching the end of its life cycle may, for example, permit a creep of a pre-specified magnitude in the product's non-conformance rate.

As an example of a policy that adjusts the target for a particular product based on product-specific guidelines, suppose it is determined that something in the process is causing product number “ABC123” to have an unusual rate of non-conformance, and that a development team is investigating the issue. A policy may be applied that changes the computed target for this particular product, while this policy is in place, by multiplying the target received at Block 270 by an appropriate factor (such as 0.9 or 1.1, by way of example).

As an example of a policy that adjusts or constrains the target for products in view of a threshold non-conformance rate, suppose that an embodiment of the present invention computes a target of 0.0164, or 1.64 percent, for a particular product. It may be determined by process control professionals that this target is not aggressive enough for this product. A post-processing policy might therefore be applied to never allow targets over 0.01 (i.e., a non-conformance rate of 1 percent). In this case, the target for the product would be revised downward to 0.01 when the policy is applied at Block 270.

As an example of a policy that adjusts the target for products having a low sample size, a policy might specify that if the combined sample size for a group is below some threshold, then the target for products in the group is to be set to the group yardstick. Suppose a particular group is comprised of 4 products, and that the observed process control data for these 4 products shows a combined sample size of 69. Further suppose that the NCI count for 2 of the 4 is zero. This may be considered unreliable data in view of the sample size. Accordingly, the targets for the 4 products may be set to the group yardstick. As will be appreciated, the determination of policy values such as what sample size invokes application of such post-processing policy is environment-specific and product-specific.

A policy may specify multiple criteria that must be met before the policy is applied. With reference to the above-discussed “revise downward” policy where the target is set to the 1 percent threshold, for example, it might be deemed appropriate to only enforce this adjustment as to particular products, or only to sample sizes below a particular threshold, or only to particular products on occasion when they have sample sizes below a particular threshold, and so forth.

Following the operation of Block 270, the processing of this iteration of trend-based target setting for the evaluated product then ends.

Further details will now be provided with regard to a preferred embodiment of computations that may be used to carry out the function of several of the above-discussed blocks of FIG. 2.

Computation of Robust Estimate

With reference to the robust estimate of NCR, as discussed above with reference to Block 210, one approach that may be used for this computation will now be described. An embodiment of the present invention analyzes process control data that is observed in multiple samples, where a sample represents data collected over an interval of time. For ease of reference, the interval is referred to hereinafter as a week. The sample “size” then represents the number of product instances tested during that week. Suppose that observed process control data is available for some number “N” weeks. The per-week sample size for a particular product may then be represented as n(1), n(2), . . . , n(N), and the per-week number of non-conforming items for a particular product may be represented as X(1), X(2), . . . , X(N). These values may be used to calculate the NCR for a product, which is referred to herein as “P”. The per-week rates of non-conformance for a particular product may be represented as P(1), P(2), . . . , P(N).

In one approach, the NCR for a product may be determined by calculating an average rate of non-conformance over all the samples for the product, as shown by equation 405 in FIG. 4. More particularly, as shown at 405, the NCR may be computed by first summing the per-week number of non-conforming items X(i), for all weeks (i) through (N), and then dividing the sum by a value that represents the sum of the per-week sample size n(i) over these same weeks.

While the approach shown by equation 405 gives one estimate of a product's NCR, this is not considered to be a robust estimate. It may happen, for example, that the observed data for a product sometimes fluctuates widely from the norm, thus introducing outliers into the data. An outlier is a week where an extremely high or extremely low count of NCI was observed. If a product is early in its life cycle or is having significant quality issues, for example, it may have a high count of NCI in one or more of the samples. It may also happen that a product temporarily performs significantly better than normal, and therefore has a low count of NCI in one or more samples. Such outliers are determined, according to a preferred embodiment, as values that lie outside the confidence interval for the product. Because these outliers are not representative of the normal fluctuations for the product, under an assumption of a stable underlying rate of non-conformance, their inclusion in the data used to set the new target would tend to skew the calculations and lead to a less reliable target. Accordingly, an embodiment of the present invention uses what is referred to herein as a “robust” estimate, “R”, of the non-conformance rate for a product, as was briefly discussed above with reference to Block 210 of FIG. 2A.

In one approach, Block 210 computes a robust estimate of the non-conformance rate for the evaluated product by applying a trimming process to derive the robust value R from the observed process control data. This trimming process comprises removing one or more instances of observed process control data that appear to be outliers. In a preferred embodiment, this trimming process begins by ordering the weekly P values—that is, the values P(i), which indicate the observed non-conformance rate for each particular week—for the evaluated product in increasing order of magnitude. Suppose, by way of example, that the resulting sequence is as shown at 410 in FIG. 4, representing data for some number of weeks “N”. As shown by this ordered sequence 410, the lowest rate of non-conformance was observed in week 5 in this example, and the highest rate was observed in week 2. After the order of P(i) values is determined, this same ordering is then applied to order the corresponding sample sizes n(i) and the corresponding NCI counts X(i). See 411, 412 (respectively) in FIG. 4, where this is illustrated.

Once the weekly data has been ordered as shown at 410-412, outliers can be discarded from the samples. A lower trimming level and an upper trimming level are used in an embodiment of the present invention in order to trim off outliers having a low NCR and also having a high NCR. These trimming levels are referred to herein as “α(1)” and “α(2)”, respectively, and represent percentages. Symmetric trimming levels may be used. Alternatively, asymmetric values may be used. By way of example, α(1) might be set to 0.1 while α(2) is set to 0.05, indicating (in this example) that the lower 10 percent of the overall sample size (i.e., the total number tested, over all of the “N” weeks) and the upper 5 percent of the overall sample size are to be discarded. Accordingly, the proportion α(1) of the overall sample size and the same proportion of the corresponding NCI counts X(i) is then discarded from the lower end of the ordered sequences, and the proportion α(2) of the overall sample size and the same proportion of the corresponding NCI counts X(i) is discarded from the upper end of the ordered sequences.

Suppose, for example, that the N weeks of samples contain 100 observed instances of data, and that 10 of these observed instances occurred in week 5, which is at the lower end of the ordered sequence. In this case, all of sample size n(5) and all of the corresponding NCI counts X(5) would then be discarded from the samples to satisfy the 10 percent lower trimming rate. It might happen, however, that week 5 contained only 8 observed instances of data. In that case, 2 more instances of data need to be discarded to account for the remaining portion of α(1). With reference to the sequence at 410, the next-lowest week in the sequence is week 1. If week 1 contains 2 observed instances of data, then the entire sample size n(1) and all of the corresponding NCI counts X(1) are also discarded. However, it may happen that this week contains more than 2 observed instances. This is referred to herein as a “boundary week” scenario, whereby the observed instances for that week will be partially, but not completely, discarded in the trimming process. When discarding observed data from a boundary week, a preferred embodiment does not recompute the NCR for that week, even though its sample size is adjusted downward to satisfy the lower trimming rate α(1).

In a similar manner, the upper trimming level α(2) is used to discard the corresponding proportion of the overall sample size from the upper end of the ordered sequences, which may result (for example) in discarding all or some of sample size n(2) in the example—that is, the sample size of highest-ordered week 2, according to the sequence at 410—and all or some of the corresponding NCI counts X(2) to satisfy the 5 percent upper trimming rate. As before, when discarding observed data from a boundary week, a preferred embodiment does not recompute the NCR for that week, but its sample size is adjusted downward to satisfy the upper trimming rate α(2).

In general, the lower trimming level causes some of the lowest-magnitude NCR values P(i) to be discarded and the upper trimming level causes some of the highest-magnitude NCR values P(i) to be discarded. Outliers are thereby removed, and a result of the processing of Block 210 is therefore a robust estimate R of the non-conformance rate of the evaluated product using the remaining (i.e., non-discarded) observed data.

Computation of Bias Correction for Robust Estimate

With reference now to the bias correction that is performed on the robust estimate R, as briefly discussed above with reference to Block 220 of FIG. 2A, one approach that may be used for this computation will now be described. In an embodiment of the present invention, this bias correction comprises first simulating some number “B” of replicated sequences of the weekly non-conformance rate P(i) for the evaluated product. For example, if B=100, then 100 sequences are created that are simulated based on the assumption that the underlying true rate of non-conformance is the same as the robust estimate R that was computed as discussed with reference to Block 210 of FIG. 2A. Note also that the replicated sequence computations assume that the sample sizes are unchanged from the values n(1), n(2), . . . n(N) which were used when creating the robust estimate R (and thus still represent a trimmed number of samples where outliers has been removed, as discussed above with reference to Block 210).

Once the robust estimate has been computed for each sequence (e.g., after trimming to remove outliers, using a robust estimate computation as discussed above), a new ordered sequence of the P(i) values is then created, based on the magnitude of the simulated NCR values. See the resampled sequence shown at 410a in FIG. 4, where the ordered simulated NCR values in this example indicate that the non-conformance rate for week 7 turned out to be the smallest when using the replicated sequences, followed by the rate for week 3, then the rate for week 6, and so forth. This new ordering from 410a is then used to order the sample sizes and the NCI counts, as shown at 411a and 412a, respectively.

The robust estimates computed for each of the replicated sequences are then summed, over all “B” of the sequences, and this sum is divided by B to yield an average rate of non-conformance that is estimated from the resampled replications. This average is referred to herein as “R(Avg)”. See equation 422 in FIG. 4. In equation 422, “RS” refers to “replicated sequence”; the “0” in the notation “(0, i)” means that the resampled NCR estimates are obtained under the assumption that the true NCR is R; and the “i” in the notation “(0, i)” is used as an index for the replicated sequences and therefore takes on the values 1 through B.

A determination is then made as to whether the value R(Avg) deviates strongly from R (i.e., from the assumed robust estimate of non-conformance), and if so, this is an indication of bias that should be corrected. Accordingly, equation 423 in FIG. 4 computes a value “r” by dividing R(Avg) by the value R (i.e., the robust estimate of NCR, as computed at Block 210), and then subtracting 1 from the resulting quotient. This value “r” is referred to herein as a bias coefficient, and indicates the magnitude of the bias in R(Avg). Note that if the value of “r” is zero, this indicates that R(Avg)=R and thus there is no bias in R(Avg).

A bias-correcting coefficient is then applied to R to correct for bias that may exist therein. This bias-correcting coefficient is represented by a value γ (gamma), where the value of gamma is typically selected from the interval [0.5, 1], and an equation for applying gamma to correct for bias in R is shown at 424 in FIG. 4. As shown therein, the bias-correcting coefficient gamma is multiplied by the computed bias coefficient “r”, and the resulting product is added to 1. The robust estimate of non-conformance R for the evaluated product is then divided by this sum, resulting in the bias-corrected robust estimate of NCR for the product. This quotient is referred to herein as “R(corr)”.

As an example of the bias computation processing, suppose the robust estimate of non-conformance R for a particular product is computed as 0.125, indicating that 125 of every 1,000 instances of this product are estimated to be non-conformant. Further suppose that the value of R(Avg) is computed by equation 422 as 0.2 (merely for illustration of the computations). Equation 423 then computes (0.2/0.125)−1)=0.6. If the bias-correcting coefficient γ is selected as 1, then the equation at 424 computes (0.125/(1+0.6))=1.6 as the bias-corrected estimate R(corr) of the NCR for the evaluated product. Or, if the bias-correcting coefficient γ is selected as 0.5 in this same scenario, then the equation at 424 computes (0.125/(1+(0.5*0.6)))=(1.25/1.3)=0.096 the bias-corrected estimate R(corr) of the NCR.

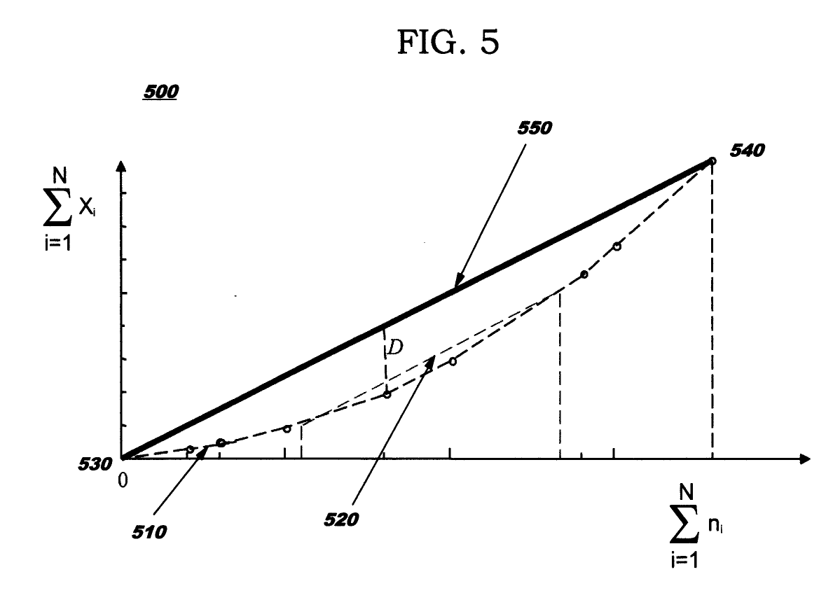

While equation 422 computes a straight average for the replicated sequences, in an alternative approach, a weighted average may be used instead. In one approach, more recent vintages (e.g., more-recent weeks, when samples correspond to weeks) are given a higher weight than older vintages in this weighted average. This may be implemented, for example, by artificially inflating the sample sizes that correspond to the more recent vintages. In addition or instead, sample sizes for older vintages may be artificially deflated. (FIG. 5, which is discussed below, provides a graph where a weighted average has been applied.)

Computation of Confidence Interval for Bias-Corrected Robust Estimate

With reference now to the confidence interval (L, U) which was briefly discussed above with reference to Block 230 of FIG. 2A, this confidence interval is computed for the bias-corrected robust estimate created at Block 220 (or for the robust estimate created at Block 210, as appropriate), and one approach that may be used for this computation will now be described. In an embodiment of the present invention, obtaining the confidence bounds of this confidence interval enables the target-setting process to limit how extreme the new target can be, as compared to the target currently in use. The process begins by computing the overall effective sample size, referred to herein as “n(eff)”, and reflects loss of estimation efficiency associated with trimming (e.g., the trimming performed at Block 210 to compute a robust estimate of NCR). An equation for computing the value of n(eff) is shown at 430 in FIG. 4, as will now be described.

The summation of n(i), where (i) takes on values from 1 to N, represents summing the sample sizes for all N weeks of observed instances. However, lower and upper trimming levels “α(1)” and “α(2)” were used to trim some proportion of the samples, as discussed with reference to Block 210. The equation at 430 uses a value “α” which is computed as the average of these trimming levels—that is, α=(α(1)+α(2))/2. Equation 430 also uses a value “u”, which is a positive coefficient determined by simulation to represent the loss of estimation efficiency from the trimming. As shown in equation 430, the product of α and “u” is subtracted from 1, and the resulting value is multiplied by the summed sample sizes to create the effective sample size n(eff).

With regard to the value “u”, simulation may be used to derived this value empirically (i.e., based on data). For example, bootstrap re-sampling analysis may be used to evaluate the expansion in variance of the robust estimate R, relative to the non-robust (but statistically more efficient) estimate P. The n(eff) value can then be directly evaluated based on this variance comparison, leading to an estimate of “u” that can be used in equation 430. Simulation may also be used to derive a formula for “u” that is applicable to a wide range of data sets. One example of such a formula is shown at 431 in FIG. 1, where “u(0)” and “u(1)” are parameters determined based on simulation studies.

Next, an effective observed NCI value is computed, representing an estimate of the number of non-conforming instances that would be observed in the trimmed sample size. This effective observed NCI is referred to herein as “X(eff)”, and as shown at equation 432, is computed by multiplying the effective overall sample size n(eff) by the bias-corrected robust estimate R(corr). Note that both X(eff) and n(eff) can be non-integer.

A function F (x, a, b) is defined to represent the cumulative distribution of the Beta-distributed random variable with parameters (a, b), as shown at 433 in FIG. 4. The upper (1−β)*100 percent confidence bound for the non-conformance rate can then be determined by solving this function for x. In this equation 433, the value X(eff)+1 represents 1 more than the estimated number of non-conforming instances in the overall effective sample size, and the value (n(eff)−X(eff)) represents the estimated number of conforming instances in the overall effective sample size. Note that when X(eff) is zero, indicating that there were no non-conformers in the entire sample, then the lower bound is also zero and the upper bound can be computed using the formula shown at 434.

Similarly, the lower (1−β)*100 percent confidence bound for the non-conformance rate can be determined by solving the equation at 435 for x. In this equation, the value X(eff) represents the estimated number of non-conforming instances in the overall effective sample size, and the value (n(eff)+1−X(eff)) represents 1 more than the estimated number of conforming instances in the overall effective sample size. Note that when X(eff)=n(eff), indicating that the entire sample was non-conforming, then the upper bound is 1 and the lower bound can be computed using the formula shown at 436.

Referring now to FIG. 5, a graph 500 is provided that uses sample data to illustrate some of the computations performed when determining the target for a product. As shown in this example, a cumulative sum of weekly sample sizes is represented on the x-axis and a cumulative sum of per-week observed NCIs is represented on the y-axis. A curve passing through the points of intersection is depicted with a dashed line at 510, and therefore shows a trend corresponding to the actual observed NCR values P for the product over the represented weeks. Application of trimming to remove outliers, as discussed above with reference to Block 210 of FIG. 2A, leads to calculation of the slope shown with a dashed line at 520, and line 520 therefore represents the robust (trimmed) estimate of non-conformance. The bold line at 550, which passes through the point of origin (0, 0) at 530 and the graphed point of intersection at 540, represents a weighted (i.e., non-robust) estimate of NCR. The x-coordinate of the point at 540 represents the total sample size over all N weeks, and the y-coordinate of the point at 540 represents the total number of non-conforming instances in this total sample size. (It should be noted that while the slope of line 520 appears similar to the slope of line 550 in FIG. 5, the slopes are not identical.)

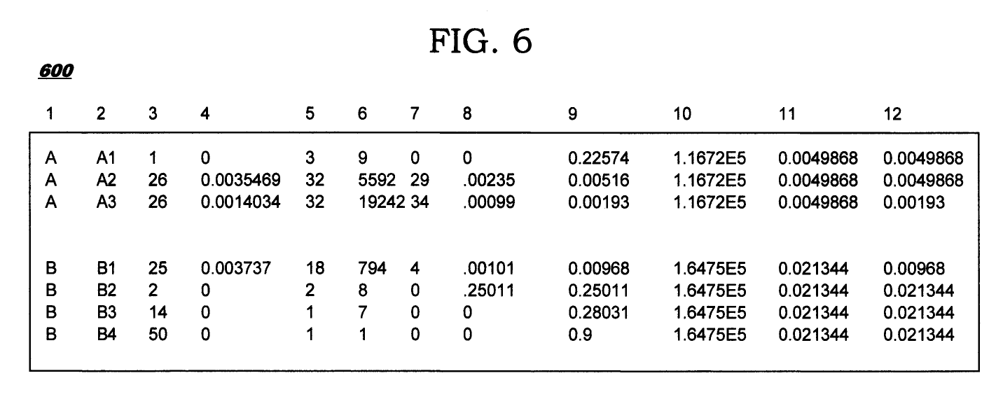

Turning now to FIG. 6, a chart 600 of sample data values is depicted, where these sample data values are used to illustrate some of the computations performed when determining a product's target. A 2-level hierarchy has been illustrated in chart 600 by way of example, although an embodiment of the present invention may support a hierarchy having more than 2 levels. The columns of chart 600 have been numbered for ease of reference. Column 1 provides a component identifier. Column 2 provides a product identifier, such as a part number. Thus, the 7 rows of sample data in chart 600 represent 7 parts which are organized into 2 components, “A” and “B”. In the example, component “A” comprises 3 parts “A1”, “A2”, and “A3”, while component “B” is comprised of 4 parts “B1” through “B4”.

Column 3 is an index value that correlates, in this example, to weeks within a year, and represents the latest week for which observed instance data is available. Column 4 contains the estimated NCR for this part. Column 5 contains the total number of weeks for which observed data is available. Column 6 contains the total number of instances tested for this part number, and column 7 contains the total number of non-conforming instances which were observed. Columns 8 and 9 contain the lower and upper 90 percent confidence bounds (L, U) for the underlying non-conformance rate.

Column 10 contains the total number of instances tested for this commodity, and thus contains an identical value for each part within a particular commodity. Column 11 contains the yardstick NCR for the commodity, and also contains an identical value for each part within a commodity. This yardstick is compared against the (L, U) confidence bounds in columns 8-9 so obtain the final target NCR for this part, which is shown in column 12. (Note that if there are no non-conforming instances—i.e., no failures—of a particular commodity, the value in column 11 is non-zero because, according to a preferred embodiment, it is based on confidence bounds. In contrast, the estimated rate for the NCR of the commodity would have been zero in this case.)

As will be obvious in view of the discussions herein, the format of chart 600 is by way of illustration but not of limitation, and additional or different values may be used without deviating from the scope of the present invention. As an example, it may be deemed useful to store various computed variability parameters such as Nmin and Nmax values. It should also be noted that the values in chart 600 are merely illustrative, and do not represent actual calculations. For example, while the count of items tested for the 3 parts “A1” through “A3” of commodity “A” is shown in column 6 as (9+5592+19242), the total count of items tested for the commodity “A” is shown in column 10 as 1.1672E5.

Whereas earlier discussions explained how data for related products of a group may be used in computing a product's target NCR, an enhanced aspect will now be described where data from multiple levels of the hierarchy may be used for computing a product's target NCR. Suppose a 4-level hierarchy is used, where level 0 is the lowest level and represents individual parts; level 1 is the next-higher level and represents sub-components which are composed of parts; level 2 is the next-higher level and represents components which are formed from sub-components; and level 3 is the highest level and represents assemblies which are formed from components.

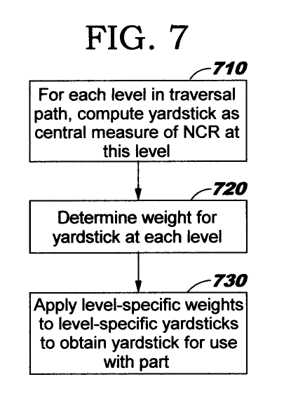

In this aspect, the target for a part is obtained using a combination of information pertaining to the part number itself and a yardstick that is computed based on the hierarchy to which the part number belongs. The yardstick used for the part, in turn, is composed as a weighted average of yardsticks corresponding to the individual hierarchies. FIG. 7 provides a flowchart depicting logic which may be used when implementing this processing, as will now be described.

A yardstick for a given level of the hierarchy is defined as some central measure, such as an average, of the robust NCR estimates corresponding to all elements within this level of the hierarchy. Block 710 of FIG. 7 therefore indicates that a yardstick is computed for each level (starting from level 1 and proceeding upward to the highest level) in the traversal path for a particular part. So, in the case of the 4-level hierarchy which was described above, yardsticks will be computed for each of levels 1, 2, and 3. For example, if there are 10 sub-components in level 1, then 10 sub-component yardsticks are computed for this level, and if these 10 sub-components are organized into 5 components in level 2, then 5 component yardsticks are computed. If the 5 components are organized into 2 assemblies in level 3, then 2 assembly yardsticks are computed.

Block 720 determines what weight should be given to the yardstick for each level, when computing a weighted average. In a preferred approach, the yardstick used when computing the target for a particular part number requires at least some threshold “K” units, where K excludes the units of the part number itself. The hierarchy is traversed upward to compute the weights needed for creating the yardstick that is used with the part number, and at each level, units are excluded in a similar manner. That is, suppose that a target is being computed for part number ABC, and that this part number is found within sub-component DEF which in turn is found within component GHI, which is found within assembly JKL. Further suppose that there are K(1) units within sub-component DEF, when not counting the units of part number ABC; that there are K(2) units within component GHI, when not counting the units of sub-component DEF; and that there are K(3) units within assembly JKL, when not counting the units of component GHI.

Weights are preferably assigned to hierarchies sequentially, and a particular level of the hierarchy preferably uses the entire 100 percent of the weight only if that level contains at least K units. Otherwise, a pro-rated weight is preferably used, relative to the value of K. If all levels of the hierarchy are traversed without accumulating the required number K of units, then the intermediate levels are preferably assigned weights as just described, with the final level being assigned the remaining weight that sums to 100 percent.

Suppose, for example, that K=100 units, and that levels 1 through 3 in a path through the hierarchy for part number ABC (for which a hierarchical structure was discussed above) contain 50, 120, and 200 units, respectively, when excluding the units as was discussed above. That is, if the sub-component DEF which is traversed in this path contains 17 units, those units are not included within the K(1)=50 units of level 1, and so forth. Because level 1 contains only 50 units, rather than the required K=100, a weight of 50/100 or 0.5 is used at this level. For level 2, these 50 units are excluded as being part of the traversal path, and thus the remaining 120−50=70 units at level 2 are then considered. Again, this is less than the required K=100 units, so level 2 will not receive 100 percent of the unallocated 50 percent of the weight. Rather, the weight for level 2 is computed as 0.5*(70/100)=0.35. That is, level 2 receives 35 percent of the total weight. The remaining 15 percent of the weight is then assigned to the yardstick for level 3, because it is the last level of the hierarchy.

Block 730 applies the level-specific weights to the level-specific yardsticks to obtain the yardstick to be used for a particular part. In the general case, this comprises computing a weighted average that may be expressed as a summation of v(i)*y(i) over i=1 to N, where N is the highest level of the hierarchy; v(i) represents the weight for level (i); and y(i) represents the yardstick for level (i). In the example, the yardstick to be used for part number ABC is therefore expressed as follows:

yardstick for ABC=v(1)y(1)+v(2)y(2)+v(3)y(3)=0.5 y(1)+0.35 y(2)+0.15 y(3)

Note that if a next-higher level of the hierarchy contains the same number of units as a preceding level, then the weight of this level of hierarchy in establishing the yardstick for the part is zero, due to the exclusion approach which was discussed.

Other techniques for selecting hierarchy weights may be used without deviating from the scope of the present invention. For example, rather than excluding units of the traversal path, those units might be factored—in whole or in part—into the computation of the weight for that level.

As has been demonstrated above, an embodiment of the present invention determines a suitable target for a product using trend-based data, where this target is practical and objective, being based on observed process control data. Hierarchical data may be used, as discussed above, to aid in setting initial targets for new products, whereby the hierarchy identifies products which are similar to the new product in some way. Observed data for those related products can therefore be used to set an initial target for the new product, thereby avoiding the establishment of arbitrary organizational targets that commonly occurs when using conventional techniques. Natural volatility in a process is mitigated, and consideration may be given to the effect that factors such as product age may have on a product in the process.

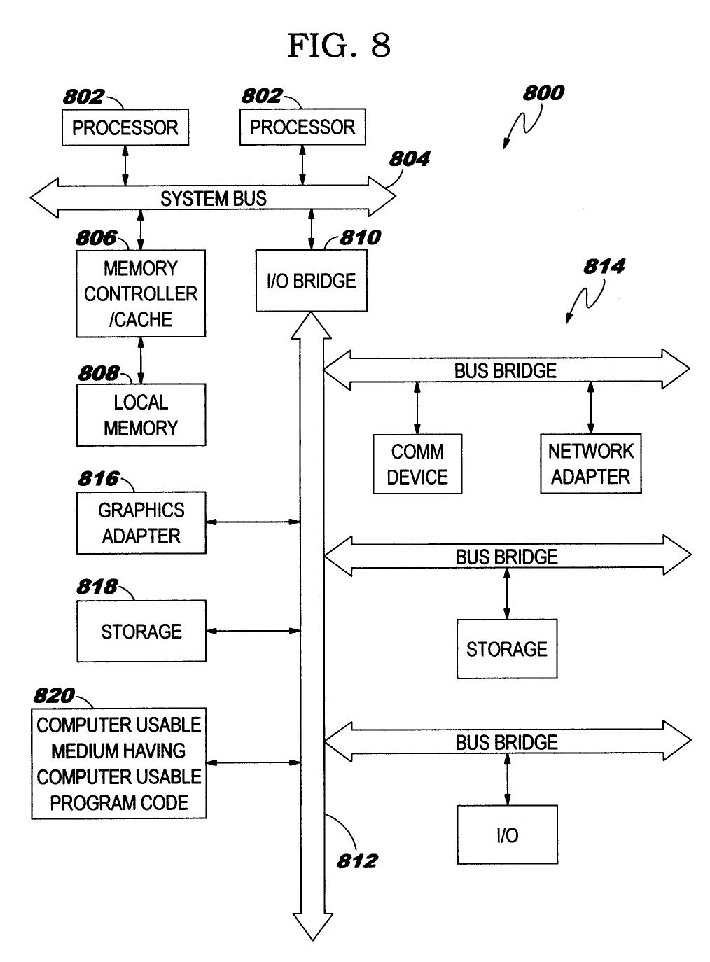

Referring to FIG. 8, a block diagram of a data processing system is depicted in accordance with the present invention. Data processing system 800, such as one of the processing devices described herein, may comprise a symmetric multiprocessor (“SMP”) system or other configuration including a plurality of processors 802 connected to system bus 804. Alternatively, a single processor 802 may be employed. Also connected to system bus 804 is memory controller/cache 806, which provides an interface to local memory 808. An I/O bridge 810 is connected to the system bus 804 and provides an interface to an I/O bus 812. The I/O bus may be utilized to support one or more buses 814 and corresponding devices, such as bus bridges, input output devices (“I/O” devices), storage, network adapters, etc. Network adapters may also be coupled to the system to enable the data processing system to become coupled to other data processing systems or remote printers or storage devices through intervening private or public networks.

Also connected to the I/O bus may be devices such as a graphics adapter 816, storage 818, and a computer usable storage medium 820 having computer usable program code embodied thereon. The computer usable program code may be executed to execute any aspect of the present invention, as have been described herein.

The data processing system depicted in FIG. 8 may be, for example, an IBM System p® system, a product of International Business Machines Corporation in Armonk, N.Y., running the Advanced Interactive Executive (AIX®) operating system. An object-oriented programming system such as Java may run in conjunction with the operating system and provides calls to the operating system from Java® programs or applications executing on data processing system. (“System p” and “AIX” are registered trademarks of International Business Machines Corporation in the United States, other countries, or both. “Java” is a registered trademark of Sun Microsystems, Inc., in the United States, other countries, or both.)

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “circuit”, “module”, or “system”. Furthermore, aspects of the present invention may take the form of a computer program product embodied in one or more computer readable media having computer readable program code embodied thereon.

Any combination of one or more computer readable media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (“RAM”), a read-only memory (“ROM”), an erasable programmable read-only memory (“EPROM” or flash memory), a portable compact disc read-only memory (“CD-ROM”), DVD, an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radio frequency, etc., or any suitable combination of the foregoing.

Computer program code for carrying out operations for aspects of the present invention may be written in any combination of one or more programming languages, including (but not limited to) an object oriented programming language such as Java, Smalltalk, C++, or the like, and conventional procedural programming languages such as the “C” programming language or similar programming languages. The program code may execute as a stand-alone software package, and may execute partly on a user's computing device and partly on a remote computer. The remote computer may be connected to the user's computing device through any type of network, including a local area network (“LAN”), a wide area network (“WAN”), or through the Internet using an Internet Service Provider.

Aspects of the present invention are described above with reference to flow diagrams and/or block diagrams of methods, apparatus (systems), and computer program products according to embodiments of the invention. It will be understood that each flow or block of the flow diagrams and/or block diagrams, and combinations of flows or blocks in the flow diagrams and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flow diagram flow or flows and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flow diagram flow or flows and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flow diagram flow or flows and/or block diagram block or blocks.

Flow diagrams and/or block diagrams presented in the figures herein illustrate the architecture, functionality, and operation of possible implementations of systems, methods, and computer program products according to various embodiments of the present invention. In this regard, each flow or block in the flow diagrams or block diagrams may represent a module, segment, or portion of code, which comprises one or more executable instructions for implementing the specified logical function(s). It should also be noted that, in some alternative implementations, the functions noted in the flows and/or blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or each flow of the flow diagrams, and combinations of blocks in the block diagrams and/or flows in the flow diagrams, may be implemented by special purpose hardware-based systems that perform the specified functions or acts, or combinations of special purpose hardware and computer instructions.

While embodiments of the present invention have been described, additional variations and modifications in those embodiments may occur to those skilled in the art once they learn of the basic inventive concepts. Therefore, it is intended that the appended claims shall be construed to include the described embodiments and all such variations and modifications as fall within the spirit and scope of the invention.

1. A computer-implemented method of trend-based target setting in a process control environment, comprising using a processor of the computer for performing:
selecting a particular entity from among a plurality of entities;
obtaining historical process control data for a group of related entities, the group comprising the selected entity and at least one additional one of the plurality of entities;
determining, from the obtained historical process control data, an observed number of non-conforming instances of each of the entities in the group and a total number of instances of each of the entities;
computing a rate of non-conformance, for each of the entities in the group, by dividing the determined number of non-conforming instances by the determined total number of instances;
computing a representative rate of non-conformance for the group, using the computed rate of non-conformance for each of the entities in the group; and
setting, as a process control target for the selected entity, an expected rate of non-conformance derived from the rate of non-conformance computed for each of the entities in the group and the computed representative rate of non-conformance for the group.

2. The method according to claim 1, wherein the related entities comprising the group are hierarchically related.

3. The method according to claim 2, wherein the entities comprising the group are products represented at a level of the hierarchy, the products together forming a commodity which is represented at a next-higher level of the hierarchy.

4. The method according to claim 1, further comprising iteratively monitoring the process control target, over a period of time, using trend analysis to determine whether the process control target is suitable for the selected entity.

5. The method according to claim 4, further comprising:
responsive to detecting that an actual rate of non-conformance for the selected entity, over the period of time, varied from the expected rate of non-conformance set as the process control target for the selected entity by more than a selected confidence interval, automatically setting, as the process control target for the selected entity, a new expected rate of non-conformance derived using the actual rate of non-conformance and a bound of the selected confidence interval.

6. The method according to claim 5, further comprising:
applying at least one policy to the new expected rate of non-conformance to adjust the process control target according to a predetermined non-conformance target guideline.

7. The method according to claim 6, wherein applying the at least one policy comprises:
determining an age of the entity; and
adjusting the process control target in view of historically-observed changes in the rate of non-conformance that results from entity age.

8. The method according to claim 4, further comprising:
computing a midpoint of a 2-sided confidence bound for the group, an interval of the 2-sided confidence bound comprising a predetermined value; and
responsive to detecting that an actual rate of non-conformance for the selected entity, over the period of time, falls outside the interval, resetting the expected rate of non-conformance to fall within (1) a first interval between a lower side of the 2-sided confidence bound and the computed midpoint and (2) a second interval between the computed midpoint and an upper side of the 2-sided confidence bound, according to whether the detected actual rate is closer to the first interval or the second interval, respectively.
